(19) United States
(12) Patent Application Publication
(10) Pub. No.: US 2025/0123148 A1
(43) Pub. Date: Apr. 17, 2025

(54) METHOD FOR MEASURING COLOR OF FABRIC, AND APPARATUS THEREFOR

(71) Applicant: H2nd Inc., Seoul (KR)

(72) Inventors: Chung Min HAM, Seoul (KR); Min Hyeok CHOI, Namyangju-si (KR); Su Ann LEE, Seoul (KR); Hyun Min LEE, Seoul (KR); Yoon Jung KANG, Seoul (KR); Young Se LEE, Seoul (KR)

(73) Assignee: H2nd Inc., Seoul (KR)

(21) Appl. No.: 18/293,843

(22) PCT Filed: Jul. 13, 2022
(86) PCT No.: PCT/KR2022/010188

§ 371 Date: Jan. 31, 2024

(30) Foreign Application Priority Data
Aug. 11, 2021 (KR) 10-2021-0106225
Aug. 23, 2021 (KR) 10-2021-0111208
Aug. 30, 2021 (KR) 10-2021-0114428

(51) Int. Cl. G01J 3/46

(52) U.S. Cl. CPC G01J 3/463

(57) ABSTRACT

The present invention provides a method by which a fabric measurement apparatus determines color information about fabric. In particular, the method may comprise the steps of: measuring a plurality of pieces of first color information about at least a part of a area of fabric input into the fabric measurement apparatus; determining an average value for the plurality of pieces of first color information; and determining second color information about the fabric based on the average value.

### TECHNICAL FIELD

The present disclosure relates to a method for measuring a color of a fabric and an apparatus therefor and, more specifically, to a method for measuring and analyzing the color of the fabric and identifying a similarity thereof to a reference color requested by an orderer, and an apparatus therefor.

### BACKGROUND ART

Since the clothing fashion business has a feature in which the trend changes rapidly, the product of the clothing fashion industry needs to be quickly produced.

Accordingly, various methods for reducing the production time of the garment fashion product are being studied. In this regard, a significant time is consumed in the process of identifying the color of the fabric, and thus there is a limit in reducing the production time.

For example, in order to check the color of the fabric, only a period of time for which a lap dip is sent to a buyer and whether the color of the fabric is the same as that of an existing lab dip requires 3 weeks to one month.

In addition, when the fabric color does not meet the requirement of the purchaser, a re-approval request should be received. Since a significant period is required for the re-approval request, there is a limitation in reducing the production time of the clothing fashion product.

Accordingly, there is a need for a method for reducing the time required for checking the color of the fabric.

### DISCLOSURE

### Technical Purpose

A purpose of an embodiment of the present disclosure is to provide accuracy and convenience in a method for measuring the color of the fabric and an apparatus therefor.

### Technical Solution

A method for determining color information of a fabric using a fabric measurement apparatus according to one embodiment of the present disclosure includes measuring a plurality of pieces of first color information on at least a partial area of the fabric inserted into the apparatus; determining an average value of the plurality of pieces of first color information; and determining second color information of the fabric based on the average value.

### Advantageous Effects

According to the present disclosure, there is no need to take a significant amount of time for checking the color of the fabric, and feedback on the color of the fabric is obtained in real time, thereby advancing a start time for the production of the garment fashion product.

### DESCRIPTION OF DRAWINGS

FIGS. 1 and 2 are views illustrating a structure of a fabric measuring apparatus according to an exemplary embodiment of the present disclosure.

FIG. 3 is a view illustrating a structure of a fabric measurement system according to the present disclosure.

FIGS. 4 to 7 are diagrams for illustrating embodiments of a method for measuring a fabric color according to the present disclosure.

### BEST MODE

Hereinafter, the present disclosure will be described in more detail with reference to the specific embodiment of the present disclosure shown in the accompanying drawings, in order to clarify the features and advantages of the problem-solving means of the present disclosure.

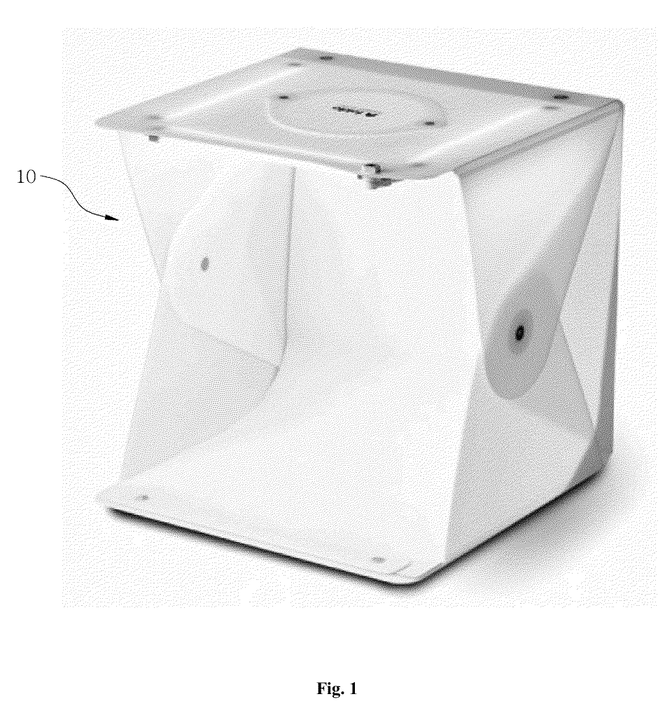

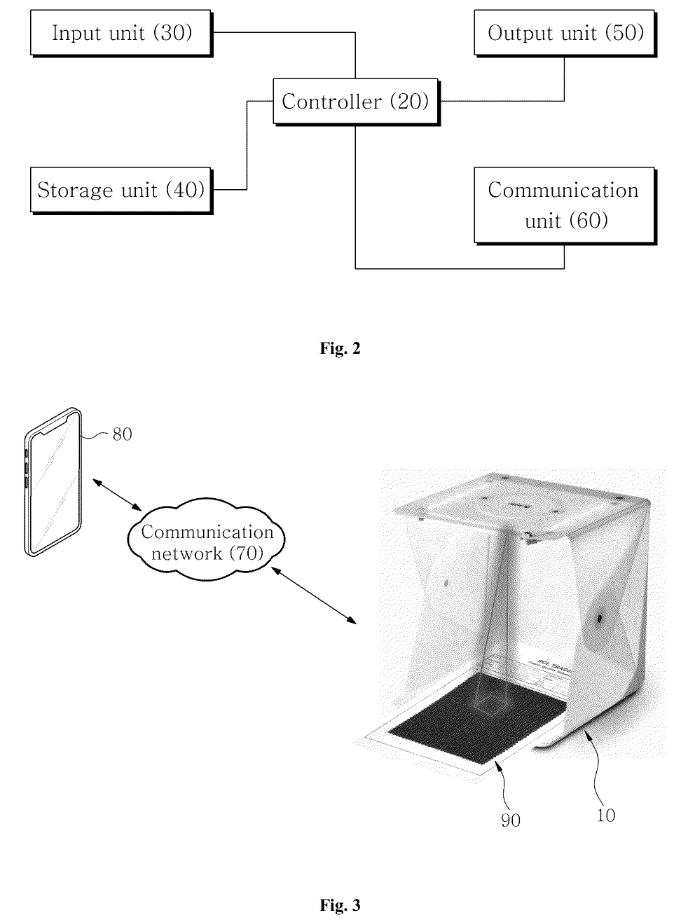

FIGS. 1 and 2 are diagrams illustrating a configuration of a fabric measuring apparatus 100.

Referring to FIG. 1, a fabric measuring apparatus 100 is configured in a form in which one surface of a hexahedron is open. The fabric may be inserted into the fabric measuring apparatus 100 through the one open surface, and the color of the fabric may be measured through an input unit 120 installed on a bottom surface of an opposite surface to the one open surface through which the fabric is inserted.

For a more detailed description, referring to FIG. 2, the fabric measuring apparatus 100 may include a controller 110, an input unit 120, a storage unit 130, an output unit 140, and a communication unit 150.

The input unit 120 receives various information such as numbers and text information, sets various functions, and transmits an input signal related to control of the fabric measuring apparatus 100 to the controller 110. In addition, the input unit 120 may include at least one of a keypad and a touchpad for generating an input signal according to a user's touch or manipulation. In this case, the input unit 120 together with the output unit 140 may be configured in a form of one touch panel (or a touch screen) to simultaneously perform input and display functions. Further, in addition to an input device such as a keyboard, a keypad, a mouse, a joystick, or the like, all types of input means that may be developed in the future may be used as the input unit.

In particular, the input unit 120 according to the present disclosure may include a specific device for measuring the color of the fabric. For example, the input unit 120 may include a camera and/or a measurement sensor for measuring the color of the fabric. The data on the fabric color measured through the input unit 120 may be transmitted to the storage unit 130 and/or the controller 110.

The storage unit 130 is a device for storing data therein, includes a main memory device and an auxiliary memory device, and stores therein an application program necessary for a function and an operation of the fabric measurement apparatus. The storage unit 130 may include a program area and a data area. In this regard, when each function is activated in response to a user's request, the fabric measuring apparatus executes a corresponding application program under the control of the controller 100 to provide each function.

In particular, the storage unit 130 according to the present disclosure stores therein data on a fabric color. For example, color information on swatches may be stored therein. In this case, the color information may be stored as an RGB value. In this regard, the swatch may mean a sample of the fabric. That is, the storage unit 130 may store therein the color information about the samples of the fabric as an RGB value.

The stored color information may be used to determine a measured color of the fabric, and the storage unit 130 may transmit the color information to the controller 110 according to a command of the controller 110.

The output unit 140 displays information on a series of operation states and operation results generated while the function of the fabric measuring apparatus 100 is executed. In addition, the output unit 140 may display a menu of the fabric measuring apparatus and user data input by the user. The output unit 140 includes a liquid crystal display (LCD) device, a thin film transistor (TFT)-liquid crystal display (LCD) device, a light emitting diode (LED) display device, an organic light emitting diode (OLED) display device, an active matrix OLED (AMOLED) display device, a retina display device, a flexible display device, or a three-dimensional (3D) display device. In this regard, when the output unit 140 is configured in the form of a touch screen, the output unit 140 may perform some or all of the functions of the input unit 120.

In the present disclosure, the output unit 140 may output information on the color of the fabric measured by the controller 110.

The communication unit 150 may transmit and receive data to and from at least one external device (e.g. a smart phone or a PC security device) through a communication network. In addition, the communication unit 150 includes an RF transmission means for up-converting and amplifying a frequency of a transmitted signal, an RF reception means for low-noise amplifying a received signal and down-converting a frequency thereof, a data processing means for processing a communication protocol according to a specific communication method, etc. The communication unit 150 may include at least one of a wireless communication module (not shown) and a wired communication module (not shown). The wireless communication module is configured to transmit and receive data according to a wireless communication method. When a driver monitoring device uses wireless communication, the wireless communication module may transmit and receive data to/from at least one external device by using any one of a wireless network communication module, a wireless LAN communication module, and a wireless PAN communication module. In this regard, the communication unit 150 may include a plurality of communication modules. When the plurality of communication modules is included in the communication unit 150, one communication module may perform a personal area network (PAN)-type communication including Bluetooth.

In addition, another communication module communicates with at least one external device through a communication network. In this regard, another communication module may use a wireless communication scheme such as WLAN Wireless LAN (WLAN), Wi-Fi, Wibro, WiMAX, High Speed Efficient Downlink Packet Access Network (HSDPA), and the like.

In this regard, the communication unit 150 may transmit the color information on the fabric color measured by the controller 110 to another external device through a communication network. In this case, another external device may be a PC device or a smart phone of a client requesting the fabric.

The controller 110 may be a process device for executing an operating system (OS) and operating each component.

Accordingly, the controller 110 of the fabric measuring apparatus may control the communication unit 150 to transmit the signal received through the input unit 120 to at least one external device, and may control the output unit 140 to display the information transmitted from the beacon, the Wi-Fi, the base station, or at least one external device as received through the communication unit 150.

In addition, the controller 110 of the fabric measuring apparatus 100 may control the overall operation process of the fabric measuring apparatus 100 according to an embodiment of the present disclosure. In other words, the overall operation process of the fabric measuring apparatus 100 according to embodiments of the present disclosure, which will be described later, may be controlled by the controller 110.

FIG. 3 is a diagram illustrating a system for measuring a color of a fabric according to an embodiment of the present disclosure.

Referring to FIG. 3, a fabric measurement system may include the fabric measurement apparatus 100, a fabric 200, a communication network 10, an external device 300, and a server 85.

The fabric measuring apparatus 100 may measure a color of the fabric 200, and may measure a color of a predetermined area of the fabric through the input unit 120 attached to a lower surface of a top of the fabric measuring apparatus 100. In this case, the predetermined area may be an area formed in a square shape, but this is merely an example. The predetermined area may be defined in various shapes such as a circular shape and a rectangular shape.

In this case, the fabric measuring apparatus 100 measures a color of the predetermined area having a predetermined area of a central portion of the fabric, and extracts an RGB value based on an average value of the measured color. Among pieces of color information of the fabric sample stored in the storage unit 130, color information having an RGB value closest to the measured RGB value is determined by the fabric measuring apparatus 100. In addition, the fabric measuring apparatus 100 may transmit identification information of a fabric sample corresponding to the determined color information to the external device 300 through the communication network 10.

In this regard, the closest RGB value may mean that a similarity between the measured RGB value and the RGB value of the color information of the fabric sample is the highest.

In this regard, the similarity may be expressed in percent (%). In this regard, the fabric measuring apparatus 100 may compare the RGB value of the color information of the fabric and the RGB value of the color of the fabric sample corresponding thereto with each other. For example, the fabric measuring apparatus 100 may calculate a first absolute value of a difference between the R value of the color information of the fabric and the R value of the fabric sample, and may calculate a first similarity (percent unit) related to the R value based on the ratio of the R value of the fabric sample and the first absolute value. Similarly, similarly as described above, the fabric measuring apparatus 100 may calculate a second absolute value of a difference between the G value of the color information of the fabric and the G value of the fabric sample, and may calculate a second similarity (percent unit) related to the G value based on the ratio of the G value of the fabric sample and the second absolute value. Further, the fabric measuring apparatus 100 may calculate a third absolute value of a difference between the B value of the color information of the fabric and the B value of the fabric sample, and may calculate a third similarity (percent unit) related to the B value based on the ratio of the B value of the fabric sample and the third absolute value. Thereafter, an average value of the first similarity, the second similarity, and the third similarity may be calculated as a final similarity which in turn is stored as a comparison value.

However, different weighs may be respectively assigned to the first similarity, the second similarity, and the third similarity based on the color. In this case, the weights may vary depending on the ratios of the R value, the G value, and the B value of the fabric sample. For example, when the fabric sample is purple, the R value, the G value, and the B value of the fabric sample may be 217, 65, and 197, respectively. Thus, the weights may be respectively assigned to the first similarity, the second similarity, and the third similarity, based on the ratio of 217:65:197.

In another example, when the fabric sample is red, the R value, the G value, and the B value of the fabric sample may be 255, 0, and 0, respectively. Thus, the weights may be respectively assigned to the first similarity, the second similarity, and the third similarity, based on the ratio of 255:1:1. That is, a value of 0 among the RGB values may correspond to the weight 1.

In one example, the fabric 200 may not have one color. For example, a design such as various shapes, patterns, characters and/or emoticons may be printed on the fabric 200. In this case, the fabric measuring apparatus 100 may determine a similarity between the design printed on the fabric 200 and a design of the fabric sample. The similarity may be measured per each design. That is, when two designs (i.e. a first design and a second design) are printed in a pattern form on the fabric sample, the fabric measuring apparatus 100 may calculate three pieces of similarity information (first, second, and third similarity) per each of the first design, the second design, and a background color of the fabric (or the fabric sample) according to the above-described method.

In addition, the overall similarity may be measured based on the three pieces of similarity information. Based on the above-described example, different weights may be applied to the first design, the second design, and the background color of the fabric, based on ratios of area sizes occupied by the first design, the second design, and the background color of the fabric in the fabric. Then, per each of the first design, the second design, and the background color of the fabric (or the fabric sample), different weighs may be respectively assigned to the first similarity, the second similarity, and the third similarity based on the color. Then, the average value of the similarities to which the weights have been applied may be calculated as the overall similarity.

In addition, the fabric measuring apparatus 100 may store the identification information of the fabric sample corresponding to the determined color information and the determined color information into the server 85. In addition, the fabric measuring apparatus 100 may store, into the server 85, the similarity calculated by comparing the color information of the fabric with the color of the fabric sample corresponding thereto together with the color information of the fabric and the identification information of the fabric sample.

In other words, the color information of the fabric, the identification information of the fabric sample corresponding thereto, and the similarity calculated by comparing the color information of the fabric with the color of the fabric sample corresponding thereto may be mapped with each other and the mapping may be stored in the server 85.

In this regard, as soon as the color information of the fabric is automatically determined without a user's input, and the identification information of the fabric sample is extracted, the color information of the fabric and the identification information of the fabric sample may be transmitted to the server 85 and stored in the server 85.

In one example, the server 85 may be integrated with the fabric measuring apparatus 100. In this case, the function of the server 85 may be performed by the storage unit 130 of the fabric measuring apparatus 100. The color information of the fabric and the identification information of the fabric sample stored in the server 85 or the storage unit 130 may be transmitted to the external device 300 through the communication network 1. In this regard, the fabric measuring apparatus 100 may receive a request signal for requesting to transmit the color information of the fabric and the identification information of the fabric sample from the external device 300. Upon receiving the request signal, the server 85 may transmit the color information of the fabric and the identification information of the fabric sample to the external device 300 in response to the request signal.

However, the color of the fabric may be measured in a deviated manner from a original color of the fabric based on a place where the fabric measuring apparatus 100 is installed and the lighting of the place. For example, an accurate color of the fabric may not be measured due to light reflection from the fabric and unwanted shading on the fabric under luminous intensity and illumination of the place where the fabric measuring apparatus 100 is installed.

Therefore, in order to determine the accurate color of the fabric, a method of correcting the measured color of the fabric is required.

Hereinafter, a method of correcting the measured color of the fabric will be described in order to solve the above-described problem.

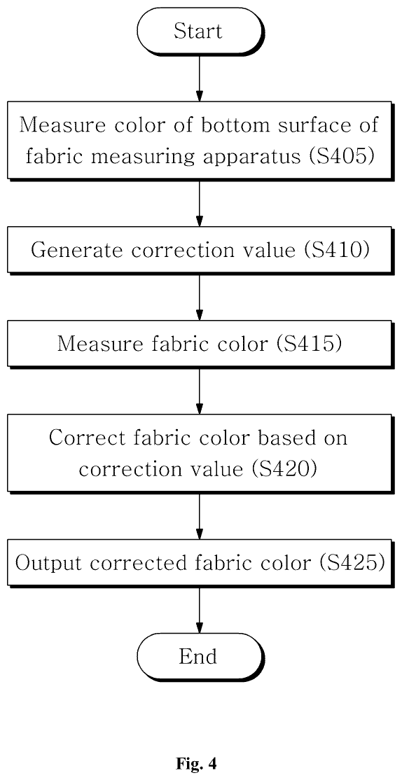

Although embodiments according to FIGS. 4 to 7 are separately described for convenience of descriptions of the present disclosure, the embodiments need not be performed independently. In other words, the embodiments according to FIGS. 4 to 7 may be performed independently, or two or more embodiments may be performed in a combined manner. For example, as long as an error between the measured color and the original color of the fabric can be reduced through the correction of the measured fabric color, two or more embodiments of embodiments #1 to #4 may be may be performed in a combined manner.

### 1. Embodiment #1

FIG. 4 is a diagram for illustrating a first embodiment of a method for correcting a measured fabric color according to an embodiment of the present disclosure.

Referring to FIG. 4, the fabric measuring apparatus 100 measures the color of the bottom surface of the fabric measuring apparatus 100 (S405). That is, in a state in which the fabric is not put into the fabric measuring apparatus 100, the color of the bottom surface of the fabric itself is measured. Then, the apparatus 100 compares the measured color of the bottom surface itself and the color of the bottom surface itself stored in the storage unit 130 with each other, and may generate a correction value based on a comparison value between the measured color and the stored color (S410).

Specifically, differences between the RGB values of the measured color and the stored color may be calculated as the correction value. For example, when the stored RGB values of the color of the bottom surface are R: 255, G: 255, B: 255 (i.e. white), and the RGB values of the color of the measured bottom surface are R: 240, G: 220, B: 210: 210, the correction value may be calculated as R: 15, G: 35, B: 45: 45.

When the fabric has been inserted into the fabric measuring apparatus 100, the fabric measuring apparatus 100 may measure the color of the fabric (S415). The measured color of the fabric may be corrected based on the above-described correction value (S420). That is, the RGB values as the correction value may be added to the measured RGB values of the color of the fabric. For example, when the RGB values of the measured color of the fabric is R: 50, G: 165, and B: 0, the correction value may be added thereto such that the corrected RGB values of the measured color of the fabric may be R: 65, G: 200, and B: 25. The color corrected information on the fabric color may be output and transmitted to the external device 300 through the communication network 1 or may be transmitted to the server 85 (S425). In this case, the color information on the compared fabric sample tougher therewith may be transmitted thereto.

### 2. Embodiment #2

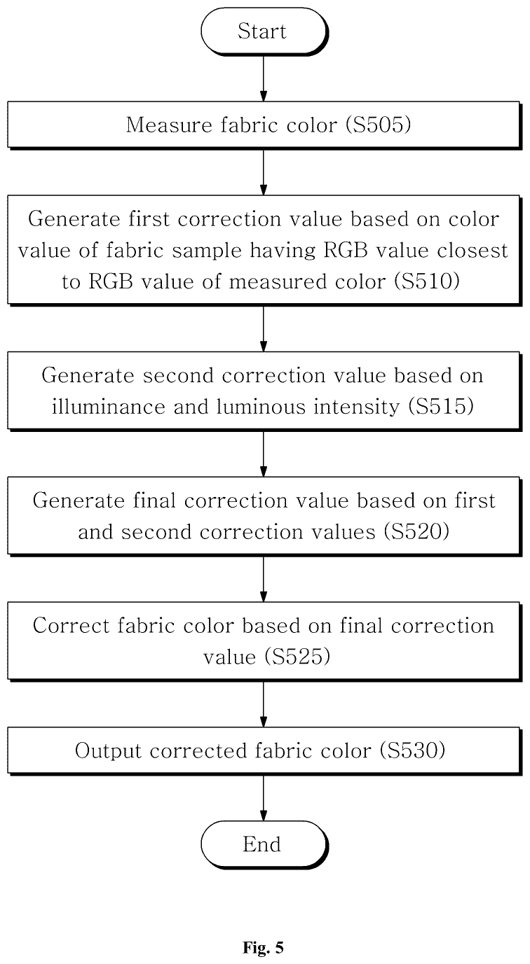

FIG. 5 is a diagram for illustrating a second embodiment of a method for correcting a measured fabric color according to an embodiment of the present disclosure.

Referring to FIG. 5, the fabric measuring apparatus 100 may measure the color of the fabric inserted into the fabric measuring apparatus 100 (S505). In this case, the value of the measured color may be expressed as an RGB value. Then, the color value of the fabric sample having the RGB value closest to the RGB value of the measured color may be compared with the RGB value of the measured color and then a first correction value may be generated based on the comparing result (S510).

In addition, the fabric measuring apparatus 100 may measure illuminance and luminous intensity of light incident into the apparatus 100 for measuring the fabric, and generate a second correction value for correcting the color of the fabric based on the illuminance and the luminous intensity (S515).

For example, the fabric measuring apparatus 100 may measure the illuminance and luminous intensity of the bottom surface (or the inserted fabric) onto which the fabric is inserted. In this regard, the server 85 or the fabric measuring apparatus 100 stores therein data about RGB color correction values based on the illuminance and the luminous intensity. Accordingly, the fabric measuring apparatus 100 may extract the RGB color correction values corresponding to the measured illuminance and luminous intensity from the server 85 or the storage unit 130 of the fabric measuring apparatus 100 and may determine the second correction value based thereon.

When the RGB color correction values corresponding to the measured illuminance and luminous intensity are not stored therein, the RGB color correction value corresponding to illuminance and luminous intensity having an error within a predetermined value from the measured illuminance and light intensity may be used. When there are a plurality of RGB color correction values corresponding to the illuminance and luminous intensity having the error within the predetermined value, an RGB color correction value corresponding to illuminance and luminous intensity having the smallest error among the illuminance and luminous intensity having the error within the predetermined value may be used.

In this case, the RGB color correction value corresponding to the measured illuminance and luminous intensity may be newly generated and stored in the server 85 or the storage unit 130 of the fabric measuring apparatus 100. For example, in this case, the correction value determined through Embodiment 1, Embodiment 3, and Embodiment 4 may be calculated as an RGB color correction value corresponding to the measured illuminance and luminous intensity, and then, the measured illuminance and luminous intensity and the corresponding RGB color correction value may be mapped with each other and the mapping may be stored in the server 85 or the fabric measurement apparatus 100.

In addition, the fabric measuring apparatus 100 may generate a final correction value based on the first correction value and the second correction value (S520). In this regard, the final correction value may be generated by applying the same weight to the first correction value and the second correction value or applying different weights thereto.

For example, when a difference between the RCB value of the color of the fabric measured by the fabric measuring apparatus 100 and the RGB value of the color of the fabric sample closest thereto is smaller than a threshold value, a weight greater than a weight corresponding to the second correction value may be added to the first correction value to generate the final correction value. Otherwise, when the difference between the RCB value of the color of the fabric measured by the fabric measuring apparatus 100 and the RGB value of the color of the fabric sample closest thereto is greater than the threshold value, a weight greater than a weight corresponding to the first correction value may be added to the second correction value to generate the final correction value.

That is, when the difference between the RCB value of the color of the fabric measured by the fabric measuring apparatus 100 and the RGB value of the color of the fabric sample closest thereto is greater than a predetermined value, it is determined that the measured color of the fabric is subjected to a large influence from the illuminance and luminous intensity. Thus, a greater weight is applied to the second correction value.

The fabric measuring apparatus 100 may correct the measured fabric color based on the final correction value (S525), output color information on the corrected fabric color, transmit the color information to the external device 300 through the communication network 10, or transmit the color information to the server 85 (S530). In this regard, the color information on the compared fabric sample together therewith may be transmitted thereto.

### 3. Embodiment #3

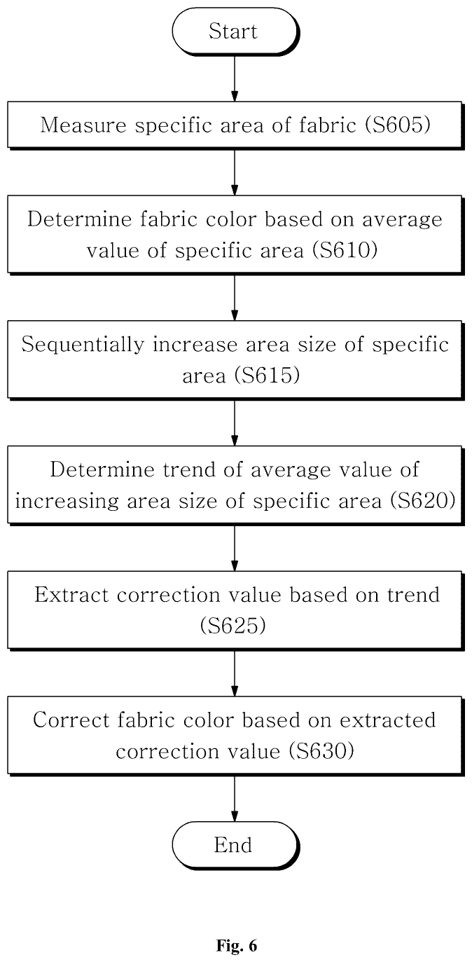

FIG. 6 is a diagram for illustrating a third embodiment of a method for correcting a measured fabric color according to an embodiment of the present disclosure.

Referring to FIG. 6, as described above, the fabric measuring apparatus 100 may measure the color of the fabric in a specific area of the fabric (S605). In this case, the specific area may be a square area, but is not limited thereto, and may be a circular, oval, or rectangular area.

The fabric measuring apparatus 100 may measure the color of the fabric in a specific area and determine the color of the fabric based on the average value of the measured color values. For example, the specific area may be divided into a plurality of sub-areas, and respective color values of the plurality of sub-areas may be measured. In addition, an average value of the respective measured color values of the plurality of sub-areas may be calculated as one average color value, and the color of the fabric may be determined based on the average color value (S610).

In this regard, in order to more accurately measure the color of the fabric, an entire area size of the specific area may be sequentially increased (S615). For example, when an initial specific area has an area size of about 2 [cm]×2 [cm] around a center of the fabric, then the area size of a next specific area may be 3 [cm]×3 [cm]. In other words, the area size may be gradually increased by an area size corresponding to a longitudinal (or transverse) length of 1.5 times of a longitudinal (or transverse) length of the initial specific area. That is, after the area of 3 cm×3 cm has been measured, the next specific area may increase to 4 [cm]×4 [cm].

In this regard, the number of the plurality of sub-areas included in the specific area may increase as the area size of the specific area increases. That is, the area size of each of the plurality of sub-areas is always constant. Thus, as the area size of the specific area increases, the number of the plurality of sub-areas increases proportionally to increase the number of the color measurement target areas in the fabric.

Alternatively, even when the area size of the specific area increases, the number of the plurality of sub-areas may always be constant. In this case, the area size of each of the plurality of sub-areas may increase in proportion to the entire area size of the specific area.

When the number of the plurality of sub-areas is increased, there may be a difference between the average value of the measured fabric color and the average value of the measured fabric color when the area size of each of the plurality of sub-areas increases.

Therefore, a scheme of configuring the plurality of sub-areas within the specific area may be an important issue. In this case, the scheme may be determined based on a combination of Embodiment #1 and Embodiment #2. For example, when a correction value on the measured color of the fabric in the initial specific area and/or a comparison value between the measured fabric color and the color of the fabric sample is smaller than a specific threshold value, it may be determined that the color of the fabric measured in the initial specific area is a relatively accurate value. Thus, as the area size of the specific area increases, the area size of each of the plurality of sub-areas increases. Thus, the colors of the fabric in the plurality of sub-areas are sequentially measured, thereby identifying the accuracy of the measured fabric color.

When the correction value on the measured color of the fabric in the initial specific area and/or the comparison value between the measured fabric color and the color of the fabric sample is greater than the specific threshold value, it may be determined that the color of the fabric measured in the initial specific area is a relatively inaccurate value. Thus, the number of the plurality of sub-areas increases as the area size of the specific area increases, thereby increasing the number of the color measurement target areas in the fabric used to obtain the average value, thereby increasing the accuracy of the fabric color measurement.

In addition, the scheme may be determined based on a feedback value received from the external device 300. For example, the information on the color of the fabric has been transmitted to the external device 300. In this case, when the feedback value thereto requires a more accurate color measurement of the fabric, the number of the plurality of sub-areas may be increased while increasing the area size of the specific area.

On the other hand, when the feedback value requires information on the overall color of the fabric, the area size of each of the plurality of sub-areas may be increased while increasing the area size of the specific area.

In one example, the fabric measuring apparatus 100 may determine change (or a change trend) of the average values of the specific area according to the above-described examples while increasing the area size of the specific area (S620). The fabric measuring apparatus 100 may determine an estimated correction value on the fabric color based on the change in the average values (S625).

In one example, the fabric is dyed in one color but at least one design is printed on the fabric. In this case, an estimated correction value on the background color and the design of the fabric may be determined using the above-described method, while sequentially increasing the entire area size of the specific area. In this regard, the fabric measuring apparatus 100 may determine the color of the printing based on the values measured in the plurality of sub-areas included in the specific area while increasing the area size of the specific area.

For example, the fabric measuring apparatus 100 measures the color value of each of the plurality of sub-areas while increasing the area size of the specific area. In this case, when a difference between the color values of adjacent sub-areas is significant, it may be determined that the printed design is present on the measured area.

That is, it is assumed that among the plurality of sub-areas included in the specific area, a first sub-area, a second sub-area, and a third sub-area are adjacent to each other. That is, it is assumed that the second sub-area is directly on the right of the first sub-area, and the third sub-area is directly on the right of the second sub-area.

When the RGB values of the first sub-area are R: 0, G: 0, B: 102, and the RGB values of the second sub-area are R: 0, G: 0, and B: 153, it may be determined that the first sub-area and the second sub-area have the color of the fabric. Thus, the first sub-area and the second sub-area may be used to determine an estimated correction value on a background color of the fabric according to the above-described method. In this regard, the R and G values of the first sub-area and those of the second sub-area may be equal to each other, while the B values thereof may be different from each other. In this case, the difference between the B values may be 31 and thus may be perceived as being within the specific threshold value. Among the RGB values of each of the first sub-area and the second sub-area, the percentage of the B value may be the highest. Thus, the first sub-area and the second sub-area may be determined to have a similar color. Thus, the first sub-area and the second sub-area may be determined to belong to the same design or color of the fabric.

However, when the RGB values of the third sub-area are measured as R: 255, G: 255, B: 51, each of the RG values thereof is 255. Thus, a difference between the R and G values of each of the first and second areas and the third area may be 255 and may be greater than the specific threshold value. A difference between the B values of each of the first and second areas and the third area may be 50 and may be greater than the specific threshold value. Among the RGB values of each of the first sub-area and the second sub-area, the percentage of the B value may be the highest. However, in the third sub-area, R and G have the greatest percentage, and B has the smallest percentage. Thus, it may be determined that the third sub-area belongs to a different design or color from the design or color corresponding to the first sub-area and the second sub-area. In other words, when the fabric measuring apparatus 100 determines that the first sub-area and the second sub-area correspond to the color of the fabric, while the third sub-area corresponds to a design.

In this regard, when the fabric measuring apparatus 100 measures the plurality of sub-areas included in the specific area while increasing the area size of the specific area, the fabric measuring apparatus 100 may group a plurality of sub-areas having a similar color characteristic, that is, having each of the RGB values smaller than the specific threshold value according to the above-described method into a single group. In this way, the plurality of sub-areas may be grouped into a plurality of groups. In addition, the group having the largest number of sub-areas included in each of the plurality of groups may be determined as the group corresponding to the color of the fabric, and the remaining groups may be determined as corresponding to different designs, respectively.

In addition, the estimated correction value per each group may be determined according to the above-described method.

In addition, the fabric measuring apparatus 100 sets an initial specific area around the center of the fabric and measure the color of the fabric step by step while increasing the area size of the specific area. Thus, a position of the design may be measured. That is, when the color value of the sub-area located adjacent to the sub-area of the second specific area corresponding to the uppermost sub-area of the initial specific area is significantly changed, it may be determined that the design is present on the measured area.

In this case, the fabric measuring apparatus 100 may divide the fabric sample into the same sub-areas in the same position as that of the specific area of the fabric currently being measured, and then determine whether the design is present at the position of the fabric sample. When it is determined that the design is present at the position of the sample, the fabric measuring apparatus 100 may determine that the measured position accuracy of the design is 100%.

However, when it is determined that there is no design at the position of the sample, the fabric measuring apparatus 100 determines whether the design is present in the fabric in the sub-areas adjacent to the sub-area in which the design should be located. When the design is absent in the adjacent sub-areas, it is determined whether the design is present in the fabric in the sub-areas adjacent to the adjacent sub-areas.

The above-described process may be repeated to measure the position accuracy based on a distance by which the sub-area in which the design is present is spaced from the sub-area in which the design should be located. For example, when the design is present in the sub-areas immediately adjacent thereto, it may be determined that the position accuracy is 95%. When the design is present in an adjacent sub-area to an adjacent sub-area thereto, it may be determined that the position accuracy is 90%.

That is, it may be determined that as the distance by which the sub-area in which the design is present is spaced from the sub-area in which the design should be located increases, the accuracy of the position may decrease.

The fabric color value measured in the initial specific area may be corrected based on the estimated correction value to obtain the corrected value which may be transmitted, as color information on the fabric color, to the external device 300 through the communication network 10 or may be transmitted, as the color information on the fabric color, to the server 85 (S630). In this regard, the color information on the compared fabric sample together therewith may be transmitted thereto. In addition, the position accuracy measured by the above-described method may be transmitted to the external device 300 through the communication network 1 or may be transmitted to the server 85.

### 4. Embodiment #4

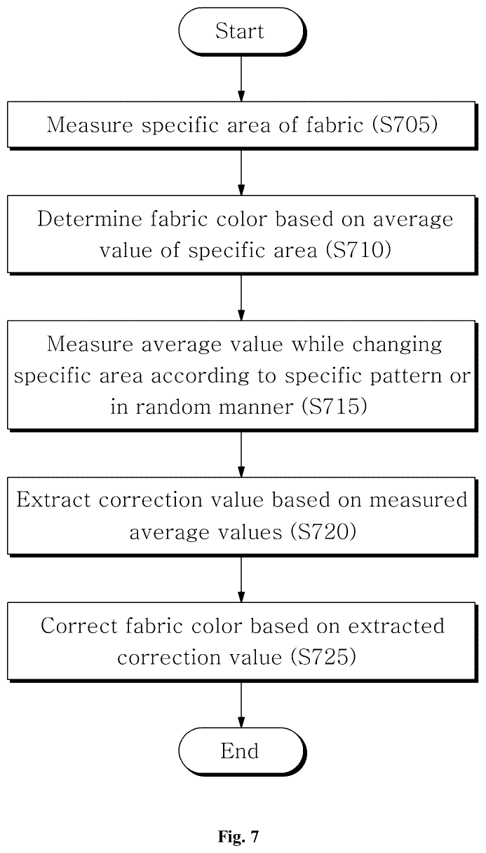

FIG. 7 is a diagram for illustrating a fourth embodiment of a method for correcting a measured fabric color according to an embodiment of the present disclosure.

Referring to FIG. 7, as described above, the fabric measuring apparatus 100 may measure the color of the fabric in a specific area of the fabric (S705). In this case, the specific area may be a square area, but is not limited thereto, and may be a circular, oval, or rectangular area.

The fabric measuring apparatus 100 may measure the color of the fabric in the specific area and determine the color of the fabric based on the average value of the measured color values. For example, the specific area may be divided into the plurality of sub-areas, and respective color values of the plurality of sub-areas may be measured. In addition, an average value of the measured respective color values of the plurality of sub-areas may be calculated as one average color value, and the color of the fabric may be determined based on the average color value (S710).

In this case, in order to more accurately measure the measured color, the average value may be measured while changing the specific area, the accuracy of the color measured in the above-described step may be determined, and the measured color may be corrected. In this regard, a deviation between a first average value of the initial specific area and a second average value measured while changing the specific area may be measured. When the deviation is small, it may be estimated that the accuracy of the measurement is high. When the deviation is large, it may be estimated that the accuracy is low. Specifically, the accuracy of the color measured in the initial specific area may be estimated based on the number of second average values having a deviation smaller than a predetermined value from the first average value. That is, a ratio of the total number of the first average value and the second average values and the number of second average values having the deviation smaller than a predetermined value from the first average value may be estimated as the accuracy of the color measured in the initial specific area.

The initial specific area may refer to a central portion of the fabric. That is, the central portion of the fabric as the initial specific area may be measured. Thereafter, the average value may be measured while the position of the specific area is changed within the position of the fabric or arbitrarily changed (S715).

In this case, a plurality of specific patterns in which a position of the specific area is changed may be stored in the storage unit 130. In addition, which pattern in which the position of the specific area is to be changed may be determined based on a comparison value between an average value measured in an initial specific area and color information of a fabric sample stored in the storage unit 130. In this regard, the color of the fabric sample to be compared may be a fabric sample having color information closest to the measured average value.

That is, when the difference between the color information of the corresponding fabric sample and the measured average value is smaller than the threshold value, the position of the specific area may be changed according to a first pattern. When the difference between the color information of the corresponding fabric sample and the measured average value exceeds the threshold value, the position of the specific area may be changed according to a second pattern.

Alternatively, the specific pattern may be determined based on values respectively measured at the plurality of sub-areas of the initial specific area. That is, the deviation between the values of the plurality of sub-areas may be measured. In other words, the deviation between the values of adjacent sub-areas may be measured. Then, a specific pattern starting at a position corresponding to a direction having the largest deviation or a number of measurement times at a position corresponding to a direction having the largest deviation may be determined. The average values may be measured while changing the position of the specific area based on the determined specific pattern.

In addition, based on the average values measured while changing the position of the specific area, a correction value for correcting the average value measured at the position of the initial specific area may be determined (S720).

In another example, when at least one design is printed on the fabric rather than the fabric is dyed with one color, an estimated correction value for the background color and the design of the fabric may be determined in the above-described method while changing the position of the specific area based on the specific pattern.

For example, a color measurement area or a measurement position in the fabric according to the plurality of specific patterns stored in the storage unit 130 may be determined. That is, the position information measured in the fabric according to each of the plurality of specific patterns and each of the plurality of specific patterns may be mapped with each other and the mapping may be stored.

In this regard, when a position of a specific area is changed according to a specific pattern using information of a fabric sample corresponding to the fabric measured by the fabric measuring apparatus 100, type information of a color to be measured may be obtained.

For example, when the RGB values of the fabric sample in the initial specific area are R: 0, G: 0, B: 102, the color type information of the initial specific area may be determined to be a first type of color having a B value of 100 to 150, and an R value and a G value of 0 to 50. In addition, when the RGB values of the fabric sample in the second specific area according to the specific pattern are R: 255, G: 255, B: 51: 51, the color type information of the second specific area may be determined as a second type of color having the B value in a range of 50 and 100, and each of R and G values in a range of 200 and 255.

The fabric measuring apparatus 100 may measure the color by the above-described method according to the specific pattern, and may determine whether the color of the same type as the color of the type corresponding to each specific area according to the specific pattern has been measured. For example, when it is determined that the color type of the initial specific area is the first type of color, and the color type of the second specific area is also the first type of the color, it is determined that the design has not been printed on a proper position. When it is determined that the color type of the specific area is the second type of color, it may be determined that the design has been printed on a proper position.

In this regard, the ratio of the number of specific areas changed according to the specific pattern and the number of specific areas in which the color types thereof do not match each other may be determined as the position accuracy.

The fabric color value measured in the initial specific area may be corrected based on the estimated correction value to obtain the corrected value which may be transmitted, as color information on the fabric color, to the external device 300 through the communication network 10 or may be transmitted, as the color information on the fabric color, to the server 85 (S725). In this regard, the color information on the compared fabric sample together therewith may be transmitted thereto. In addition, the position accuracy measured by the above-described method may be transmitted to the external device 300 through the communication network 1 or may be transmitted to the server 85.

As described above, although the present disclosure includes the details of multiple specific implementations, they should not be understood as limiting the present disclosure or the scope of the claim, but rather are to be understood as a description of features that may be specific to a particular embodiment of the particular disclosure. Certain features described herein in the context of separate embodiments may be implemented in combination with each other in a single embodiment. Conversely, the various features described in the context of a single embodiment are also implemented in a plurality of embodiments, either individually or in any suitable sub-combination. Furthermore, although features may be depicted as operating in a particular combination with each other and initially depicted as such as claimed as such, one or more features from the claimed combination may in some cases be excluded from the combination, and the claimed combination may be changed to a variant of a sub-combination or a sub-combination.

### INDUSTRIAL APPLICABILITY

The present disclosure relates to a method for measuring the color of a fabric and an apparatus therefor and, more specifically, to a method for measuring and analyzing the color of a fabric and identifying the similarity thereof with a reference color requested by an orderer, and an apparatus therefor.

According to the present disclosure, there is no need to take a significant amount of time for checking the color of the fabric, and feedback on the color of the fabric is sent in real time, thereby advancing the start time for the production of the garment fashion product.

Therefore, the present disclosure may contribute to the development of the entire clothing fashion industry through the method for measuring the color of the fabric and the apparatus therefor, and is industrially applicable as well as sufficient possibility of commercial or business, and thus is industrially applicable.

1. A fabric measurement apparatus for determining color information of a fabric, the apparatus comprising: an accommodation unit; a measurement unit; and a controller,
wherein the controller is configured to:
measure a plurality of pieces of first color information on at least a partial area of the fabric inserted into the accommodation unit;
determine an average value of the plurality of pieces of first color information; and
determine second color information of the fabric based on the average value,
wherein the controller is further configured to:
before the fabric is inserted into the apparatus,
measure color information of a bottom surface of the fabric measuring apparatus; and
generate a correction value based on color information of the bottom surface,
wherein the controller is further configured to determine the second color information of the fabric based on the average value and the correction value.

2. A method for determining color information of a fabric using a fabric measurement apparatus, the method comprising:
measuring a plurality of pieces of first color information on at least a partial area of the fabric inserted into the apparatus;
determining an average value of the plurality of pieces of first color information; and
determining second color information of the fabric based on the average value,
wherein the method further comprises:
before the fabric is inserted into the apparatus,
measuring color information of a bottom surface of the fabric measuring apparatus; and
generating a correction value based on color information of the bottom surface,
wherein the determining of the second color information includes determining the second color information of the fabric based on the average value and the correction value.

3. The method of claim 2, further comprising:
generating a first correction value based on third color information of a fabric sample having color information closest to the average value;
generating a second correction value based on illuminance and light intensity of the fabric measurement apparatus; and
generating a final correction value based on the first correction value and the second correction value,
wherein the determining of the second color information of the fabric includes determining the second color information of the fabric based on the average value and the final correction value.

4. The method of claim 2, wherein the measuring of the plurality of pieces of first color information includes measuring a plurality of pieces of first color information on an initial specific area of the fabric,
wherein the method further comprises generating a correction value based on a plurality of pieces of fourth color information measured while sequentially increasing an area size of the initial specific area,
wherein the determining of the second color information includes determining the second color information of the fabric based on the average value and the correction value.

5. The method of claim 2, wherein the measuring of the plurality of pieces of first color information includes measuring a plurality of pieces of first color information on an initial specific area of the fabric,
wherein the method further comprises:
measuring a plurality of pieces of fifth color information while changing a specific area according to a specific pattern; and
generating a correction value based on the plurality of fifth color information,
wherein the determining of the second color information includes determining the second color information of the fabric based on the average value and the correction value.
